(19) United States
(12) Patent Application Publication
(10) Pub. No.: US 2023/0170531 A1
(43) Pub. Date: Jun. 1, 2023

(54) STACKED STRUCTURE THIN FILM, ELECTROCHEMICAL BATTERY COMPRISING STACKED STRUCTURE THIN FILM, AND PREPARATION METHOD THEREOF

(71) Applicants: Samsung Electronics Co., Ltd., Suwon-si (KR); Seoul National University R&DB Foundation, Seoul (KR)

(72) Inventors: Sewon Kim, Suwon-si (KR); Yun Seog Lee, Seoul (KR); Mingi Moon, Seoul (KR); Changhyun Lim, Seoul (KR)

(21) Appl. No.: 17/991,891

(22) Filed: Nov. 22, 2022

(30) Foreign Application Priority Data
Nov. 30, 2021 (KR) 10-2021-0169527
Nov. 8, 2022 (KR) 10-2022-0148196

(51) Int. Cl. H01M 10/0585; H01M 10/0562

(52) U.S. Cl. CPC H01M 10/0585; H01M 10/0562; H01M 2300/0071

(57) ABSTRACT

A stacked structure including: a conductive substrate; and a solid electrolyte layer disposed on one surface of the conductive substrate, wherein the solid electrolyte layer includes an inorganic solid electrolyte and the stacked structure has a flexible free-standing film having a thickness of about 5 μm or less. Provided are an electrochemical battery including the stacked structure, and a method of preparing the stacked structure.

### CROSS-REFERENCE TO RELATED APPLICATIONS

This application claims priority and the benefit of Korean Patent Application No. 10-2021-0169527, filed on Nov. 30, 2021, in the Korean Intellectual Property Office, and Korean Patent Application No. 10-2022-0148196, filed on Nov. 8, 2022, in the Korean Intellectual Property Office, and all the benefits accruing therefrom under 35 U.S.C. § 119, the contents of which in their entirety are herein incorporated by reference.

### BACKGROUND

### 1. Field

Provided are a stacked structure, an electrochemical battery including the same, and a method of preparing the same.

### 2. Description of the Related Art

Batteries with high energy density and stability are actively being developed. For example, lithium-ion batteries may not only be used in fields related to information-related devices and communication devices, but also in the automobile industry. In the automobile industry, safety is an important factor.

Lithium-ion batteries may utilize a liquid electrolyte containing a flammable organic solvent, and in the event of a short-circuit, may undergo overheating and cause, e.g., catch, fire. In this context, batteries using a solid electrolyte, in place of a liquid electrolyte, may be used.

Batteries using a solid electrolyte may not use flammable organic solvents, and even in the event of a short-circuit, can greatly decrease the risk of fire or explosion. Batteries using a solid electrolyte can significantly increase safety, compared to batteries using a liquid electrolyte.

An aspect provides a stacked structure which forms a flexible free-standing film and can be applied to, e.g., used in, various processes.

An aspect provides an electrochemical battery provided with the disclosed stacked structure.

Additional aspects will be set forth in part in the description which follows and, in part, will be apparent from the description, or may be learned by practice of the presented embodiments of the disclosure.

According to an embodiment, provided is a stacked structure including: a conductive substrate; and a solid electrolyte layer disposed on one surface of the conductive substrate, wherein the solid electrolyte layer includes an inorganic solid electrolyte and the stacked structure is a flexible free-standing film having a thickness of about 5 micrometers (μm) or less.

According to an aspect, an electrochemical battery including: a first electrode-electrolyte assembly; and a second electrode, wherein the first electrode-electrolyte assembly includes the stacked structure, the first electrode includes a first electrode active material layer, and the second electrode includes a second electrode active material layer.

According to an aspect, provided is a method of preparing a stacked structure, the method including: providing a first structure including a base layer; forming a second structure by sequentially positioning a solid electrolyte layer and a conductive substrate on one side of the base layer; and exfoliating the solid electrolyte layer from the base layer to prepare the stacked structure, wherein the solid electrolyte layer includes an inorganic solid electrolyte and stacked structure is a flexible free-standing film having a thickness of about 5 μm or less.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an image of a stacked structure prepared in Example 1 in a bent state.

FIG. 2 is an image of a stacked structure prepared in Example 1 in a flat state.

FIG. 3 is an atomic force microscopy (“AFM”) image of a stacked structure prepared in Example 1.

FIG. 4 is an AFM image of a stacked structure prepared in Example 3.

FIG. 5 is a Nyquist plot and is a graph of imaginary impedance (Z′, Ohms) versus real impedance (Z, Ohms) and shows the results of complex impedance analysis from electrochemical impedance spectroscopy (“EIS”) of a stacked structure prepared in Example 1.

FIGS. 6A to 6H are schematic diagrams of an embodiment of a method of preparing a stacked structure.

FIGS. 7A to 7C are schematic diagrams of an embodiment of a method of preparing an electrochemical battery.

FIGS. 8A to 8C are schematic diagrams of an embodiment of a method of preparing an electrochemical battery.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept described below may have various modifications and various embodiments, and will be described in greater details in conjunction with specific embodiments illustrated in the drawings. The present inventive concept may, however, should not be construed as limited to the example embodiments set forth herein, and rather, should be understood as covering all modifications, equivalents, or alternatives falling within the scope of the present inventive concept.

The terms used herein is for the purpose of describing particular embodiments only, and is not intended to be limiting the present inventive concept. As used herein, the singular are intended to include the plural forms as well, unless the context clearly indicates otherwise. For example, as used herein, “a”, “an,” “the,” and “at least one” do not denote a limitation of quantity, and are intended to include both the singular and plural, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. As used herein, “/” may be interpreted as “and”, or as “or” depending on the context.

In the drawings, thicknesses may be magnified or exaggerated to clearly illustrate various layers and regions. Like reference numbers may refer to like elements throughout the drawings and the following description. It will be understood that when one element, layer, film, section, sheet, etc. is referred to as being “on” or “above” another element, it can be directly on the other element or intervening elements may be present therebetween. Although the terms “first,” “second,” etc. may be used herein to describe various elements, these elements should not be limited by these terms. These terms are only used to distinguish one element from another element.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used, e.g., non-technical, dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, a C-rate means a current which will discharge a battery in one hour, e.g., a C-rate for a battery having a discharge capacity of 1.6 ampere-hours would be 1.6 amperes.

In the present disclosure, the term “metal” includes, in an element state or an ionic state, a metal and a metalloid, such as silicon or germanium.

In the present disclosure, the term “alloy” refers to a mixture of two or more metals.

In the present disclosure, the term “electrode active material” refers to an electrode material that may undergo lithiation and delithiation.

In the present disclosure, the terms “lithiation” and “lithiate” refer to the process of adding lithium to an active material.

In the present disclosure, the terms “delithiation” and “delithiate” refer to the process of removing lithium from an active material.

In the present disclosure, the terms “charging” and “charge” refer to the process of providing electrochemical energy to a battery.

In the present disclosure, the terms “discharging” and “discharge” refer to the process of removing electrochemical energy from a battery.

In the present disclosure, the terms “positive electrode” and “cathode” refer to an electrode at which electrochemical reduction and lithiation take place during a discharging process.

In the present disclosure, the terms “negative electrode” and “anode” refer to an electrode at which electrochemical oxidation and delithiation take place during a discharging process.

Hereinbelow, a stacked structure, a secondary battery including the same, and a method of preparing the same, according to example embodiments, will be described in greater detail.

### Stacked Structure Thin Film

A stacked structure thin film (also referred to herein as a “stacked structure”) according to an embodiment includes a conductive substrate; and a solid electrolyte layer disposed on a side of the conductive substrate, wherein the solid electrolyte layer includes an inorganic solid electrolyte, and the stacked structure thin film is a flexible free-standing film having a thickness of about 5 micrometers (μm) or less. The phrase “stacked structure thin film” as used herein refers to a stacked structure that can also be described as a film, which has a relatively thin thickness.

A solid electrolyte layer obtained by coating a solid electrolyte slurry on a metal substrate may have a thickness of a few tens to a few hundred micrometers. A battery including a solid electrolyte layer having such a thickness may have a reduced energy density. Degradations such as cracks may occur in a thick solid electrolyte layer, and durability of such a solid electrolyte layer may suffer. In a solid electrolyte layer obtained by sequentially depositing a metal current collector layer and a solid electrolyte on a substrate, the substrate used for deposition may not have flexibility, and it may be difficult to obtain a flexible free-standing film therefrom.

The stacked structure thin film of the present disclosure has flexibility, even when the stacked structure thin film is bent, and may not cause the solid electrolyte layer to crack. The stacked structure thin film is a free-standing film and as such, may be easy to handle. The stacked structure thin film can be applied to, e.g., used in, various processes and for various applications where, e.g., in which, a flexible thin film solid electrolyte layer is desired. The thickness of the stacked structure thin film is about 5 μm or less, and a battery including the stacked structure thin film may have a desirable energy density.

Flexibility can be characterized by radius of curvature. A radius of curvature of the stacked structure thin film may be, for example, about 10 millimeters (mm) or less, about 5 mm or less, about 3 mm or less, about 1 mm or less, about 0.5 mm or less, about 0.2 mm or less, or 0.17 mm or less. A radius of curvature of the stacked structure thin film may be, for example, about 0.01 mm to about 10 mm, about 0.1 mm to about 5 mm, about 0.1 mm to about 3 mm, about 0.1 mm to about 1 mm, about 0.1 mm to about 0.5 mm or less, about 0.1 mm to about 0.2 mm, or about 0.1 mm to about 0.17 mm. By having a radius of curvature in the disclosed ranges, the stacked structure thin film can provide an improved flexibility. The stacked structure thin film, having a radius of curvature within the disclosed ranges, may be bent at various angles. The stacked structure thin film, having a curvature of radius in the disclosed ranges, may be bent at about 5 degrees to about 180 degrees, about 30 degrees to about 180 degrees, about 45 degrees to about 180 degrees, about 90 degrees to about 180 degrees, or about 120 degrees to about 180 degrees. The stacked structure thin film may be used in articles of various shapes, such as a battery.

A thickness of the solid electrolyte layer may be, for example, about 70% or less, about 60% or less, about 50% or less, about 40% or less, about 30% or less, about 20% or less, or about 10% or less, of a thickness of the conductive substrate. A thickness of the solid electrolyte layer may be, for example, about 1% to about 70%, about 5% to about 60%, about 5% to about 50%, about 5% to about 40%, about 5% to about 30%, about 5% to about 20%, or about 5% to about 10%, of a thickness of the conductive substrate. By having a thickness in the disclosed ranges, the solid electrolyte layer can impart an improved flexibility to the stacked structure thin film. The amount of stress for exfoliation of the solid electrolyte layer from a base layer increases with an increase in the thickness of the solid electrolyte layer. If the size, e.g., amount, of stress applied to the solid electrolyte layer from the conductive substrate becomes smaller, e.g., less than, than the size, e.g., amount, of the stress to exfoliate the solid electrolyte layer, exfoliation of the solid electrolyte layer from the base layer may become difficult.

A thickness of the solid electrolyte layer may be, for example, about 1 μm or less, about 900 nanometers (nm) or less, about 800 nm or less, about 700 nm or less, about 600 nm or less, or about 500 nm or less. The thickness of the solid electrolyte layer may be, for example, about 100 nm to about 1 μm, about 100 nm to about 900 nm or less, about 100 nm to about 800 nm, about 100 nm to about 700 nm, about 100 nm to about 600 nm, or about 100 nm to about 500 nm. When the solid electrolyte layer has a thickness in the disclosed ranges, improved flexibility can be imparted to the stacked structure thin film. The amount of the stress to exfoliate the solid electrolyte layer from the base layer increases with an increase in the thickness of the solid electrolyte layer. If the size, e.g., amount, of a stress applied to the solid electrolyte layer from the conductive substrate becomes smaller, e.g., less than, than the size, e.g., amount, of stress for exfoliation of the solid electrolyte layer, exfoliation of the solid electrolyte layer from the base layer may become difficult.

The root mean square (RMS) roughness R_{RMS} of a surface of the solid electrolyte layer may be, for example, about 5 nm or less, about 4 nm or less, about 3 nm or less, or about 2 nm or less. The R_{RMS} of the surface of the solid electrolyte layer may be, for example, about 0.1 nm to about 5 nm, about 0.1 nm to about 4 nm, about 0.1 nm to about 3 nm, or about 0.1 nm to about 2 nm. A maximum roughness Rₘₐₓ of a surface of the solid electrolyte layer may be, for example, about 10 nm or less, about 7 nm or less, about 5 nm or less, about 4 nm or less, about 3 nm or less, or about 2 nm or less. The maximum roughness Rₘₐₓ of the surface of the solid electrolyte layer may be, for example, about 0.1 nm to about 10 nm, about 0.1 nm to about 7 nm, about 0.1 nm to about 5 nm, about 0.1 nm to about 4 nm, about 0.1 nm to about 3 nm, or about 0.1 nm to about 2 nm. A mean roughness (Rₐ) of a surface of the solid electrolyte layer may be, for example, about 5 nm or less, about 4 nm or less, about 3 nm or less, or about 2 nm or less. The mean roughness Rₐ of the solid electrolyte layer surface may be, for example, about 0.1 nm to about 5 nm, about 0.1 nm to about 4 nm, about 0.1 nm to about 3 nm, or about 0.1 nm to about 2 nm. When the surface of the solid electrolyte layer has a low surface roughness in the disclosed ranges, the solid electrolyte layer having a uniform surface state can be obtained. A roughness of the solid electrolyte layer surface may be measured by an atomic force microscope, a scanning electron microscope, or the like.

A surface area of the solid electrolyte layer may be, for example, about 50% or greater, about 60% or greater, about 70% or greater, about 80% or greater, about 90% or greater, or 100%, of a surface area of the conductive substrate. The surface area of the solid electrolyte layer may be, for example, about 50% to about 100%, about 60% to about 100%, about 70% to about 100%, about 80% to about 100%, or about 90% to about 100%, of the surface area of the conductive substrate. That is, the solid electrolyte layer may shield, for example, about 50% or greater, about 60% or greater, about 70% or greater, about 80% or greater, about 90% or greater, or 100%, of the conductive substrate. When the solid electrolyte layer has a surface area in the disclosed ranges, a large-surface solid electrolyte layer of various shapes can be realized.

The solid electrolyte layer may be, for example, an exfoliated layer. The solid electrolyte layer may be, for example, an exfoliated layer exfoliated from a base layer. When the solid electrolyte layer is an exfoliated layer exfoliated from the base layer, a stacked structure thin film having a thickness of about 5 μm or less can be formed. For example, a stacked body including the solid electrolyte layer and the conductive substrate may be exfoliated from the base layer and prepared.

A solid electrolyte may have an ion conductivity of, for example, about 1×10⁻⁸ siemens per centimeter (S/cm) or greater, about 1×10⁻⁷ S/cm or greater, or about 1×10⁻⁶ S/cm or greater. The ion conductivity of the solid electrolyte may be, for example, about 1×10⁻⁸ S/cm to about 1×10⁻³ S/cm, about 1×10⁻⁷ S/cm to about 1×10⁻⁴ S/cm, or about 1×10⁻⁶ S/cm to about 1×10⁻⁵ S/cm. When the solid electrolyte has an ion conductivity in the disclosed ranges, an increase in internal resistance of a battery including the stacked structure thin film can be suppressed, and improved cycle characteristics can be provided. The ion conductivity of the solid electrolyte may be calculated from, for example, a Nyquist plot obtained by electrochemical impedance spectroscopy (“EIS”).

The inorganic solid electrolyte may be, for example, an oxide-based solid electrolyte. The oxide-based solid electrolyte may be, for example, an amorphous solid electrolyte, a crystalline solid electrolyte, or a combination thereof. The amorphous solid electrolyte may have superior resistance to cracks or the like, compared to a crystalline solid electrolyte. The amount of an amorphous solid electrolyte included in the solid electrolyte layer may be about 60% to about 100%, about 70% to about 100%, about 80% to about 100%, or about 90% to about 100%, with respect to the total weight of the solid electrolyte layer. The oxide-based solid electrolyte may be, for example, lithium phosphorus oxynitride (“UPON”), Li₃ₓLa_{(2/3-x)(1/3-2x)}TiO₃ (0.04<x<0.16) (“LLTO”), Li₁₊ₓAlₓTi₂₋ₓ(PO₄)₃ (0<x<2, “LATP”), Li₁₊ₓAlₓGe₂₋ₓ(PO₄)₃ (0<x<2, “LAGP”), Li_{1+x+y}AlₓTi₂₋ₓSi_{y}P_{3-y}O₁₂ (0<x<2, 0≤y<3), BaTiO₃, Pb(Zr, Ti)O₃ (“PZT”), Pb₁₋ₓLaₓZr_{1-y}Ti_{y}O₃ (“PLZT”, 0≤x<1, 0≤y<1), Pb(Mg_{1/3}Nb_{2/3})O₃—PbTiO₃ (“PMN-PT”), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, or Zr, 1≤x≤10), Li₇La₃Zr₂O₁₂ (“LLZO”), and Li₃₊ₓLa₃Zr₂₋ₐMₐO₁₂ (M doped LLZO, M=Ga, W, Nb, Ta, or Al, 0<a<2, 1≤x≤0), or a combination thereof. The oxide-based solid electrolyte may be, for example, LiPON.

A thickness of the conductive substrate may be, for example, about 4 μm or less, about 3.5 μm or less, about 3 μm or less, about 2.5 μm or less, about 2 μm or less, about 1.5 μm or less, or about 1 μm or less. The thickness of the conductive substrate may be, for example, about 0.5 μm to about 4 μm, about 0.5 μm to about 3.5 μm, about 0.5 μm to about 3 μm, about 0.5 μm to about 2.5 μm, about 0.5 μm to about 2 μm, or about 1 μm to about 2 μm. When the conductive substrate has a thickness in the disclosed ranges, improved flexibility can be imparted to a stacked structure thin film. Flexibility of the stacked structure thin film may decrease with an increase of thickness of the conductive substrate. The conductive substrate may apply a stress to the solid electrolyte layer and facilitate the exfoliation the solid electrolyte layer from the base layer. The stress applied to the solid electrolyte layer by the conductive substrate may decrease with a decrease in the thickness of the conductive substrate, and it may be difficult to exfoliate the solid electrolyte layer from the base layer.

A residual stress of the conductive substrate may be selected for more convenient exfoliation from the base layer, depending on the type of the inorganic solid electrolyte included in the solid electrolyte layer.

The inorganic solid electrolyte may be LiPON, and the residual stress of the conductive substrate may be, for example, about 200 megaPascals (MPa) or greater, about 300 MPa or greater, about 400 MPa or greater, about 500 MPa or greater, or about 800 MPa or greater. The residual stress of the conductive substrate may be, for example, about 200 MPa to about 1,500 MPa, about 300 MPa to about 1,500 MPa, about 400 MPa to about 1,500 MPa, about 500 MPa to about 1,500 MPa, or about 800 MPa to about 1,500 MPa. When the conductive substrate has a residual stress in the disclosed ranges, the LiPON solid electrolyte layer can be exfoliated from the substrate. If the residual stress of the conductive substrate is less than the disclosed range, exfoliation of the LiPON solid electrolyte layer may become difficult. The stress applied to the LiPON solid electrolyte layer by the conductive substrate may be similar to, or higher than, the adhesive strength between the solid electrolyte layer and the substrate, and exfoliation of the LiPON solid electrolyte layer from other layers, e.g., the base layer, may become easy.

When the inorganic solid electrolyte is LLTO, the residual stress of the conductive substrate may be, for example, about 50 MPa or less. The residual stress of the conductive substrate may be, for example, about 10 MPa to about 50 MPa, about 20 MPa to about 50 MPa, or about 30 MPa to about 50 MPa. When the conductive substrate has a residual stress in the disclosed ranges, the LLTO solid electrolyte layer may be conveniently exfoliated from the substrate. If the residual stress of the conductive substrate is greater than the disclosed range, exfoliation of the LLTO solid electrolyte layer may become difficult.

The conductive substrate may include, for example, nickel (Ni), aluminum (Al), copper (Cu), or an alloy thereof, or a combination thereof. The conductive substrate may apply a stress to the solid electrolyte layer and facilitate the exfoliation the solid electrolyte layer from the base layer. The type of the conductive substrate may be selected in accordance with the thickness of the solid electrolyte layer and the type of the base layer desired.

The stacked structure thin film may further include an interlayer positioned between the conductive substrate and the solid electrolyte layer. By further including the interlayer, the adhesive strength between the conductive substrate and the solid electrolyte layer may be further improved. A thickness of the interlayer may be, for example, about 100 nm or less, about 50 nm or less, about 30 nm or less, or about 20 nm or less. The thickness of the interlayer may be, for example, about 10 nm to about 100 nm, about 10 nm to about 50 nm, about 10 nm to about 30 nm, or about 10 nm to about 20 nm. When the interlayer has a thickness in the disclosed ranges, the adhesive strength between the conductive substrate and the solid electrolyte layer may be further improved without a decrease in the stress applied to the solid electrolyte layer by the conductive substrate. If the thickness of the interlayer is less than the disclosed range, the increase in the adhesive strength between the conductive substrate and the solid electrolyte layer may be negligible. If the thickness of the interlayer is greater than the disclosed range, the stress applied to the solid electrolyte layer by the conductive substrate may decrease. The interlayer may include, for example, titanium (Ti), chromium (Cr), tungsten (W), niobium (Nb), an alloy thereof, or a combination thereof.

The stacked structure thin film may further include a release layer positioned on the other side of the conductive substrate. When preparing the stacked structure thin film, the release layer is positioned on the stacked structure thin film, and the stacked structure thin film is exfoliated from the base layer by pulling the release layer. Subsequently, by separating the release layer from the exfoliated stacked structure thin film, the stacked structure thin film may be prepared. The type of the release layer is not particularly limited, and may be any suitable layer that can be separated under a certain condition after being disposed as an adhesive layer. The release layer may be, for example, a thermal release film. The thermal release film refers to a film that has an adhesive strength at room temperature, but can be separated by heating, for example, at a high temperature of about 90° C. or greater. The release layer may be, for example, a polymer film. The release layer may be positioned on the stacked structure thin film, and the stacked structure thin film can be applied to various processes. The release layer may act as a carrier layer of a sort that carries the stacked structure thin film.

The stacked structure thin film may further include an electrode active material layer positioned between the conductive substrate and the solid electrolyte layer. The stacked structure thin film may further include an electrode active material layer between the conductive substrate and the solid electrolyte layer, and an electrode/solid electrolyte layer assembly may be formed. The electrode active material layer included in the stacked structure thin film may include a cathode active material or an anode active material.

### Solid Electrolyte Free-Standing Film

A solid electrolyte free-standing film may be prepared by immersing the disclosed stacked structure thin film in an aqueous solution containing hydrofluoric acid (HF), nitric acid (HNO₃), hydrogen peroxide (H₂O₂), or a combination thereof, and then selectively etching the conductive substrate. The concentration of, and immersion time in hydrofluoric acid (HF), nitric acid (HNO₃), hydrogen peroxide (H₂O₂), or a combination thereof may be selected in accordance with a thickness or the like, of the conductive substrate desired and used. The solid electrolyte free-standing film may be used, for example, as an electrode protection layer, a gas barrier film, or the like. The solid electrolyte free-standing film may be used, for example, as an oxygen barrier film or a protection layer of a lithium metal anode.

### Electrochemical Battery

An electrochemical battery according to an embodiment includes: a first electrode-electrolyte assembly; and a second electrode, and the first electrode-electrolyte assembly includes the disclosed stacked structure thin film, a first electrode includes a first electrode active material layer, and the second electrode includes a second electrode active material layer. For example, the first electrode may be a cathode and the second electrode may be an anode. The first electrode may be an anode and the second electrode may be a cathode. For example, the first electrode active material may be a cathode active material, and the second electrode active material may be an anode active material. The first electrode active material may be an anode active material, and the second electrode active material may be a cathode active material.

The electrochemical battery may be a primary battery or a secondary battery. The electrochemical battery may be, for example, an alkali metal battery or an alkaline earth metal battery. The electrochemical battery may be, for example, a sodium battery, a potassium battery, a magnesium battery, or a lithium battery. The electrochemical battery may be, for example, a lithium-air battery, a lithium-sulfur battery, a lithium thin film battery, a flexible battery, or the like.

### Preparation Method of Stacked Structure Thin Film

A method of preparing a stacked structure thin film includes: providing a first structure including a base layer; forming a second structure by sequentially disposing a solid electrolyte layer and a conductive substrate on one side of the base layer; and preparing a stacked structure thin film by exfoliating the solid electrolyte layer from the base layer, wherein the solid electrolyte layer includes an inorganic solid electrolyte, and the stacked structure thin film is a flexible free-standing film having a thickness of about 5 μm or less.

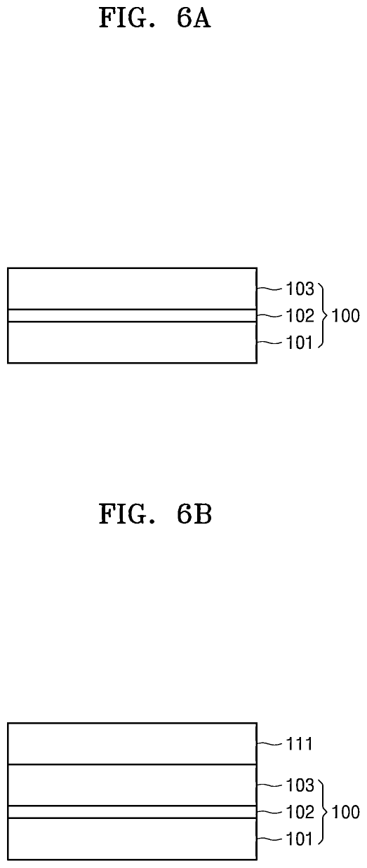

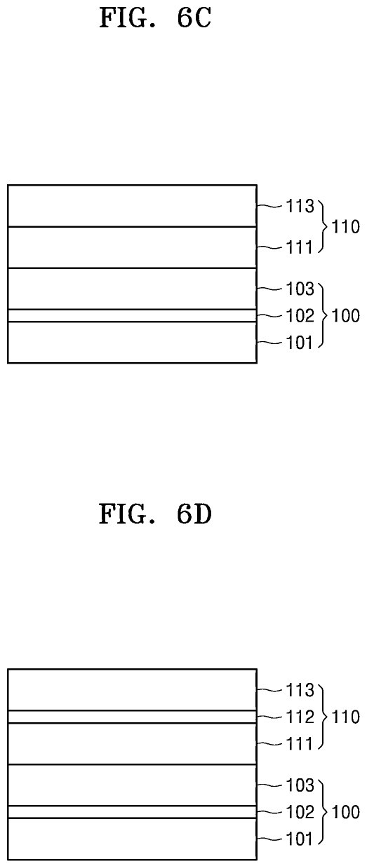

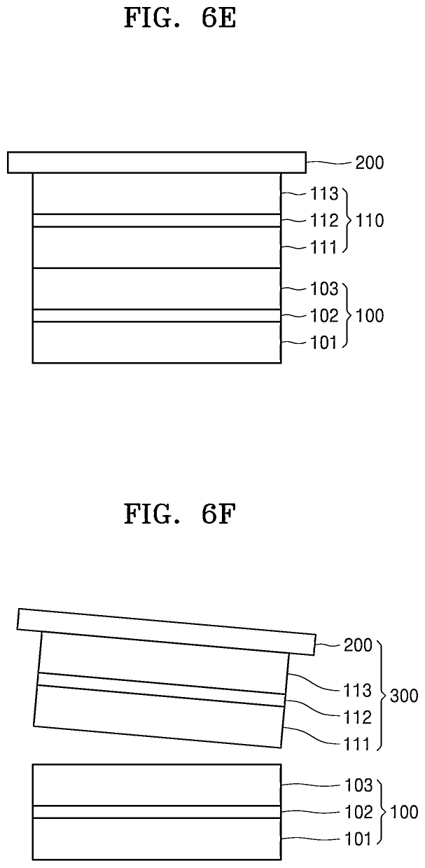

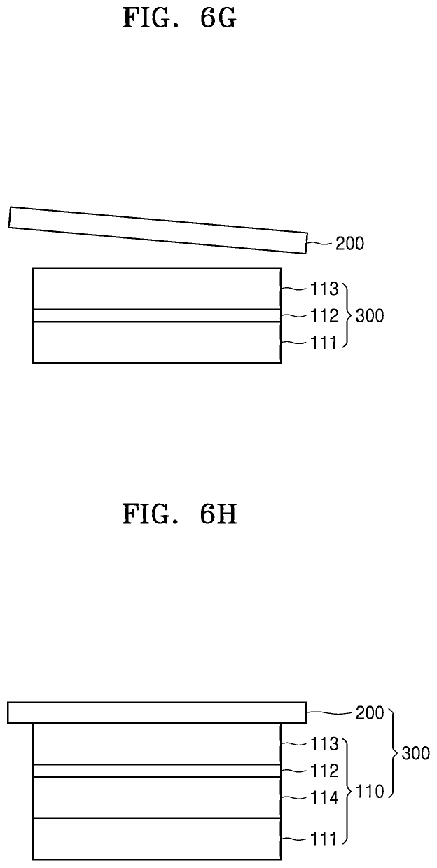

FIG. 6A to FIG. 6H are schematic diagrams of a preparation method of a stacked structure according to an embodiment.

First, a first structure 100 including a base layer 101 is provided.

The provision of the first structure 100 including the base layer 101 includes, for example: providing a substrate 101; positioning a first interlayer 102 on the substrate 101; and positioning a base layer 103 on the first interlayer 102.

The substrate 101 is provided. The substrate 101 is not particularly limited and may be any suitable substrate that is used in manufacturing of stacked bodies in the relevant technical field. The substrate 101 may be, for example, glass, silica, quartz, alumina, or the like. The substrate may be electrically insulating.

The first interlayer 102 is disposed on the substrate 101. The method by which the first interlayer 102 is disposed is not particularly limited, but may be a dry method in that a thin film having a thickness of about 100 nm or less is prepared. For the dry method, for example, an amorphous layer can be prepared by a method such as atomic layer deposition (“ALD”), chemical vapor deposition (“CVD”), and physical vapor deposition (“PVD”), but the method is not limited thereto and may be any suitable method that is used in the relevant technical field. The CVD method may be for example, thermal chemical vapor deposition (“thermal CVD”), plasma enhanced CVD (“PECVD”), atmospheric pressure CVD (“APCVD”), low pressure CVD (“LPCVD”), or the like. The PVD may be, for example, a thermal evaporation method, an electron-beam evaporation method, a sputtering method, or the like. The first interlayer 102 may include, for example, titanium (Ti), chromium (Cr), tungsten (W), niobium (Nb), an alloy thereof, or a combination thereof. A thickness of the first interlayer 102 may be, for example, about 1 nm to about 100 nm, about 5 nm to about 50 nm, about 10 nm to about 50 nm, about 10 nm to about 30 nm, or about 10 nm to about 20 nm. The first interlayer 102 may be absent. The first interlayer 102 may serve to enhance adhesion between the substrate 101 and the base layer 103.

The base layer 103 is positioned on the first interlayer 102. If the first interlayer 102 is absent, the base layer 103 is positioned on the substrate 101. As the base layer 103 is positioned on the substrate or the first interlayer 102, the first structure 100 is formed. The method by which the base layer 103 is positioned may be a method by which the first interlayer 102 is positioned. The base layer 103 may be a layer that includes, for example, Sc, V, Cr, Mn, Fe, Co, Ni, Cu, Zn, Y, Zr, Nb, Mo, Ru, Rh, Pd, Ag, Cd, Hf, Ta, W, Re, Os, Ir, Pt, Au, or an alloy thereof. The base layer 103 may be a metal layer formed of such metals. The base layer 103 may be selected in accordance with the type of a solid electrolyte layer 111 and the type of the conductive substrate 101. A thickness of the base layer 103 may be, for example, about 0.5 μm to about 10 μm, about 0.5 μm to about 5 μm, about 0.5 μm to about 3 μm, about 0.5 μm to about 2.5 μm, about 0.5 μm to about 2 μm, or about 1 μm to about 2 μm. The thickness of the base layer 103 may be, for example, about 1 nm to about 500 nm, about 1 nm to about 200 nm, about 1 nm to about 100 nm, about 1 nm to about 50 nm, about 1 nm to about 30 nm, about 1 nm to about 25 nm, about 1 nm to about 20 nm, or about 2 nm to about 10 nm.

Subsequently, referring to FIGS. 6B and 6C, as the solid electrolyte layer 111 and the conductive substrate 113 are subsequently positioned on one side of the base layer 103, a second structure 110 is formed.

The solid electrolyte layer 111 is positioned on one side of the base layer 103. The method by which the solid electrolyte layer 111 is positioned may be a described method by which the interlayer is positioned. A thickness of the solid electrolyte layer 111 may be, for example, about 100 nm to about 1 μm, about 100 nm to about 900 nm or less, about 100 nm to about 800 nm, about 100 nm to about 700 nm, about 100 nm to about 600 nm, or about 100 nm to about 500 nm. A solid electrolyte forming the solid electrolyte layer 111 may be an oxide-based solid electrolyte. The oxide-based solid electrolyte may be stable in the air and may not include an additional application of pressure or the like after the battery is assembled.

A conductive substrate 113 is positioned on one surface of the solid electrolyte layer 111. As the conductive substrate 113 is positioned on the solid electrolyte layer 111, the second structure 110 is formed.

The method by which the conductive substrate 113 is positioned may be a described method by which the first interlayer 102 is positioned. The conductive substrate 113 may include, for example, nickel (Ni), aluminum (Al), copper (Cu), or an alloy thereof, or a combination thereof. The material of the conductive substrate 113 may be selected in accordance with a desired stress, the type of the base layer 103, and the thickness of the solid electrolyte layer 111. A thickness of the conductive substrate 113 may be, for example, about 0.5 μm to about 4 μm, about 0.5 μm to about 3.5 μm, about 0.5 μm to about 3 μm, about 0.5 μm to about 2.5 μm, about 0.5 μm to about 2 μm, or about 1 μm to about 2 μm. The thickness of the conductive substrate 113 may be selected in accordance with a desired stress.

The residual stress of the conductive substrate 113 may be selected for more convenient exfoliation from the base layer 103, depending on the type of the inorganic solid electrolyte included in the solid electrolyte layer 111. The inorganic solid electrolyte may be LiPON, and the residual stress of the conductive substrate 113 may be, for example, about 200 MPa to about 1,500 MPa, about 300 MPa to about 1,500 MPa, about 400 MPa to about 1,500 MPa, about 500 MPa to about 1,500 MPa, or about 800 MPa to about 1,500 MPa. When the inorganic solid electrolyte is LLTO, the residual stress of the conductive substrate 113 may be, for example, about 10 MPa to about 50 MPa, about 20 MPa to about 50 MPa, or about 30 MPa to about 50 MPa.

Referring to FIG. 6D, before the conductive substrate 113 is disposed on the solid electrolyte layer 111, a second interlayer 112 may be additionally disposed. The second interlayer 112 disposed on the solid electrolyte layer 111 may be a material and thickness used for the first interlayer 102 positioned on the substrate 101. The second interlayer 112 positioned on the solid electrolyte layer 111 may have the same material and thickness as the first interlayer 112 positioned on the substrate 101. The second interlayer 112 may serve to enhance adhesion between the solid electrolyte layer 111 and the conductive substrate 113. The second interlayer 112 may be absent.

Referring to FIG. 6E, a release layer 200 may be additionally positioned on the conductive substrate 113. The release layer 200 plays a role of allowing the second structure 110 to be exfoliated from the first structure 100.

Subsequently, the stacked structure thin film 300 is formed by exfoliating the solid electrolyte layer 111 from the base layer 103.

The release layer 200 may be designed to have a larger surface area than that of the second structure 110. Referring to FIG. 6F, by pulling the release layer 200, the solid electrolyte layer 111 of the second structure 110 is exfoliated from the base layer 103 of the first structure. When the conductive substrate 113 has a residual stress of about 200 MPa or greater, the conductive substrate 113 may apply a stress to the solid electrolyte layer 111 and the base layer 103, and the solid electrolyte layer 111 can be cleanly and completely exfoliated from the base layer 103 through critical exfoliation. If the residual stress of the conductive substrate 113 is too low, the thickness of the conductive substrate 113 is too small, or the adhesive strength between the solid electrolyte layer 111 and the base layer 103 is too high, the solid electrolyte layer 111 may be only partially exfoliated from the base layer 103 through subcritical exfoliation (for example, about 30% or less of the surface area of the solid electrolyte positioned on the base layer 103), or may be unable to be exfoliated. Specific conditions for critical exfoliation of the solid electrolyte layer 111, e.g., the type and thickness of the conductive substrate 113, the type of the base layer 103, the thickness of the solid electrolyte layer 111, and the type of the solid electrolyte, may be selected in accordance with the structure of the stacked structure thin film 300. If the stress of the conductive substrate 113 is too high, or the thickness of the conductive substrate 113 is too large, the solid electrolyte layer 111 may be exfoliated through spontaneous exfoliation during the preparation process of the second structure 110, it may be difficult to prepare the stacked structure thin film 300. The surface area of the solid electrolyte layer 111 included in the stacked structure thin film 300 after exfoliation may be about 50% or greater, about 60% or greater, about 70% or greater, about 80% or greater, about 90% or greater, or 100% of the surface area of the solid electrolyte layer 111 positioned on the base layer 103. The majority of the solid electrolyte layer 111 positioned on the base layer 103 may be obtained for the stacked structure thin film 300.

Subsequently, referring to FIG. 6G, the release layer 220 may be separated from the stacked structure thin film 300. The release layer 200 may be a thermal releasing film. The release layer 200 may be separated from the stacked structure thin film 300 by a heat treatment or the like. The heat treatment temperature may be about 90° C. to about 150° C., or about 90° C. to about 100° C. The heat treatment time may be about 1 minute to about 30 minutes, or about 1 minute to about 10 minutes.

Referring to FIG. 6H, during forming of the second structure 110, the electrode active material layer 114 may be additionally disposed on the solid electrolyte layer 111 prior to disposing the conductive substrate 113 on the solid electrolyte layer 111.

For example, the second structure 110 may have the structure of the solid electrolyte layer 111/the electrode active material layer 114/the interlayer 112/the conductive substrate 113, and the electrode-electrolyte layer assembly can be prepared. The method by which the electrode active material layer 114 is positioned may be a described method by which an interlayer is positioned. The electrode active material layer 114 may be positioned by a wet method. A thickness of the electrode active material layer 114 may be, for example, about 0.5 μm to about 100 μm, about 0.5 μm to about 50 μm, about 0.5 μm to about 10 μm, about 0.5 μm to about 5 μm, about 0.5 μm to about 4 μm, about 0.5 μm to about 3 μm, about 0.5 μm to about 2 μm, or about 0.5 μm to about 1 μm, but is not necessarily limited to the disclosed ranges and may be appropriately adjusted within a range that allows for the preparation of a stacked structure thin film.

The electrode active material may be a cathode active material. In this case, a cathode-solid electrolyte layer 111 assembly may be formed. The cathode active material may be, for example, a lithium transition metal oxide such as lithium cobalt oxide (“LCO”), lithium nickel oxide, lithium nickel cobalt oxide, lithium-nickel-cobalt-aluminum oxide (“NCA”), lithium-nickel-cobalt-manganese oxide (“NCM”), lithium manganate, and lithium iron phosphate; nickel sulfide; copper sulfide; lithium sulfide; iron oxide; or vanadium oxide, etc. but is not limited thereto and may be any suitable material that is used as a cathode active material in the relevant technical field. The cathode active material may be one kind of material or a mixture of two or more kinds of materials.

The lithium transition metal oxide may be, for example, a compound represented by: LiₐA_{1-b}B′_{b}D₂ (in the formula, 0.90≤a≤1 and 0≤b≤0.5); LiₐE_{1-b}B′_{b}O_{2-c}D_{c} (in the formula, 0.90≤a≤1, 0≤b≤0.5, and 0≤c≤0.05); LiE_{2-b}B′_{b}O_{4-c}D_{c} (in the formula, 0≤b≤0.5 and 0≤c≤0.05); LiₐNi_{1-b-c}Co_{b}B′_{c}D_{α} (in the formula, 0.90≤a≤1, 0≤b≤0.5, 0≤c≤0.05, and 0<α≤2); LiₐN_{1-b-c}Co_{b}B′_{c}O_{2-α}F′_{α} (in the formula, 0.90≤a≤1, 0≤b≤0.5, 0≤c≤0.05, and 0<α<2); LiₐNi_{1-b-c}Co_{b}B′_{c}O_{2-α}F′₂ (in the formula, 0.90≤a≤1, 0≤b≤0.5, 0≤c≤0.05, and 0<α<2); LiₐNi_{1-b-c}Mn_{b}B′_{c}D_{α} (in the formula, 0.90≤a≤1, 0≤b≤0.5, 0≤c≤0.05, and 0<α<2); LiₐNi_{1-b-c}Mn_{b}B′_{c}O_{2-α}F′_{α} (in the formula, 0.90≤a≤1, 0≤b≤0.5, 0≤c≤0.05, and 0<α<2); LiₐNi_{1-b-c}Mn_{b}B′_{c}O_{2-α}F′₂ (in the formula, 0.90≤a≤1, 0≤b≤0.5, ≤0≤c≤0.05, and 0<α<2); LiₐNi_{b}E_{c}G_{d}O₂ (in the formula, 0.90≤a≤1, 0≤b≤0.9, 0≤c≤0.5, and 0.001≤d≤0.1); LiₐNi_{b}Co_{c}Mn_{d}GeO₂ (in the formula, 0.90≤a≤1, 0≤b≤0.9, 0≤c≤0.5, 0≤d≤0.5, and 0.001≤e≤0.1); LiₐNiG_{b}O₂ (in the formula, 0.90≤a≤1 and 0.001≤b≤0.1); LiₐCoG_{b}O₂ (in the formula, 0.90≤a≤1, and 0.001≤b≤0.1); LiₐMnG_{b}O₂ (in the formula, 0.90≤a≤1 and 0.001≤b≤0.1); LiₐMn₂G_{b}O₄ (in the formula, 0.90≤a≤1 and 0.001≤b≤0.1); QO₂; QS₂; LiQS₂; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); and LiFePO₄. In the compound, A is Ni, Co, Mn, or a combination thereof; B′ is Al, Ni, Co, Mn, Cr, Fe, Mg, Sr, V, a rare-earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof, I′ is Cr, V, Fe, Sc, Y, or a combination thereof; and J is V, Cr, Mn, Co, Ni, Cu, or a combination thereof. A compound having a coating layer added on a surface of the compound may also be used, or a mixture of the compound and a compound having a coating layer added thereon may also be used. The coating layer added on the surface of the compound may include, for example, a compound of a coating element, such as an oxide or a hydroxide of the coating element, an oxyhydroxide of the coating element, an oxycarbonate of the coating element, or a hydroxycarbonate of the coating element. Compounds forming the coating layer may be amorphous or crystalline. The coating element included in the coating layer may be Mg, Al, Co, K, Na, Ca, Si, Ti, V, Sn, Ge, Ga, B, As, Zr, or a combination thereof. The method by which the coating layer is formed should not adversely affect the physical properties of a cathode active material. The coating method may be, for example, a spray coating method, a dipping method, or the like.

The cathode active material may include, for example, a lithium salt of a disclosed transition metal oxides that has a layered rock salt type structure. The “layered rock salt type structure” is for example, a structure where, e.g., in which, an oxygen atom layer and a metal atom layer are alternatingly regularly arranged in <111> directions in a cubic rock salt type, and as a result, each atom layer forms a two-dimensional plane. The “cubic rock salt type” represents a NaCl type structure, which is one type of lattice structure, and specifically represents a structure in which the face centered cubic lattices (fcc) formed by each cation and anion are obliquely positioned by ½ of the ridge of the unit lattice. The lithium transition metal oxide having such a layered rock salt type structure may be, for example, a tertiary lithium transition metal oxide, such as LiNiₓCo_{y}Al_{z}O₂ (“NCA”) (0<x<1, 0<y<1, 0<z<1, and x+y+z=1) or LiNiₓCo_{y}Mn_{z}O₂ (“NCM”) (0<x<1, 0<y<1, 0<z<1, and x+y+z=1). When the cathode active material includes a tertiary lithium transition metal oxide having a layered rock salt type structure, the energy density and thermal stability of an all-solid secondary battery 1 are further improved.

The cathode active material may be, for example, a lithium transition metal oxide represented by Formulas 1 to 8.

LiₐNiₓCo_{y}M_{z}O_{2-b}A_{b} Formula 1

In Formula 1, 1.0≤a≤1.2, 0≤b≤0.2, 0.8≤x<1, 0<y≤0.3, 0<z≤0.3, and x+y+z=1, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, S, Cl, Br, or a combination thereof.

LiNiₓCo_{y}Mn_{z}O₂ Formula 2

LiNiₓCo_{y}Al_{z}O₂ Formula 3

In Formulas 2 to 3, 0.8≤x≤0.95, 0≤y≤0.2, 0<z≤0.2, and x+y+z=1.

LiNiₓCo_{y}Mn_{z}Al_{w}O₂ Formula 4

In Formula 4, 0.8≤x≤0.95, 0≤y≤0.2, 0<z≤0.2, 0<w≤0.2, and x+y+z+w=1.

LiₐCoₓM_{y}O_{2-b}A_{b} Formula 5

In Formula 5, 1.0≤a≤1.2, 0≤b≤0.2, 0≤y≤0.1, and x+y=1, and M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, S, Cl, Br, or a combination thereof.

LiₐNiₓMn_{y}M′_{z}O_{2-b}A_{b} Formula 6

In Formula 6, 1.0≤a≤1.2, 0≤b≤0.2, 0<x≤0.3, 0.5≤y<1, 0<z≤0.3, and x+y+z=1, M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is F, S, Cl, Br, or a combination thereof.

LiₐM1ₓM2_{y}PO_{4-b}X_{b} Formula 7

In Formula 7, 0.90≤a≤1.1, 0≤x≤0.9, 0≤y≤0.5, 0.9<x+y<1.1, and 0≤b≤2, M1 is chromium (Cr), manganese (Mn), iron (Fe), cobalt (Co), nickel (Ni), copper (Cu), zirconium (Zr), or a combination thereof, M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X is 0, F, S, P, or a combination thereof.

LiₐM3_{z}PO₄ Formula 8

In Formula 8, 0.90≤a≤1.1 and 0.9≤z≤1.1, M3 is chromium (Cr), manganese (Mn), iron (Fe), cobalt (Co), nickel (Ni), copper (Cu), zirconium (Zr), or a combination thereof.

The electrode active material may be, for example, an anode active material. In this case, an anode-solid electrolyte layer 111 assembly may be prepared.

The anode active material may be any suitable material that is used as an anode active material for lithium batteries in the relevant technical field. For example, the anode active material includes lithium metal, a metal that can be alloyed with lithium, a transition metal oxide, a non-transition metal oxide, a carbon-based material, or a combination thereof. Examples of the metal that can be alloyed with lithium may include Si, Sn, Al, Ge, Pb, Bi, Sb Si—X alloys (wherein X is an alkali metal, an alkali earth metal, a Group 13 element, a Group 14 element, a transition metal, a rare-earth element, or a combination of the disclosed elements, and is not Si), an Sn—X alloy (Here, X is an alkali metal, an alkali earth metal, an element in Group 13, an element in Group 14, a transition metal, a rare-earth element, or a combination of the disclosed elements, and is not Sn), and the like. Element X is, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. The transition metal oxide may be, for example, a lithium titanium oxide, a vanadium oxide, a lithium vanadium oxide, or the like. The non-transition metal oxide may be, for example, SnO₂, SiOₓ (0<x<2), or the like. The carbon-based material may be, for example, a crystalline carbon, an amorphous carbon, or a combination thereof. Examples of the crystalline carbon may include graphite, including artificial graphite or natural graphite in shapeless, plate, flake, spherical or fiber form. Examples of the amorphous carbon may include soft carbon (low-temperature calcined carbon) or hard carbon, mesophase pitch carbides, calcined cokes, and the like.

### Preparation Method for Electrochemical Battery

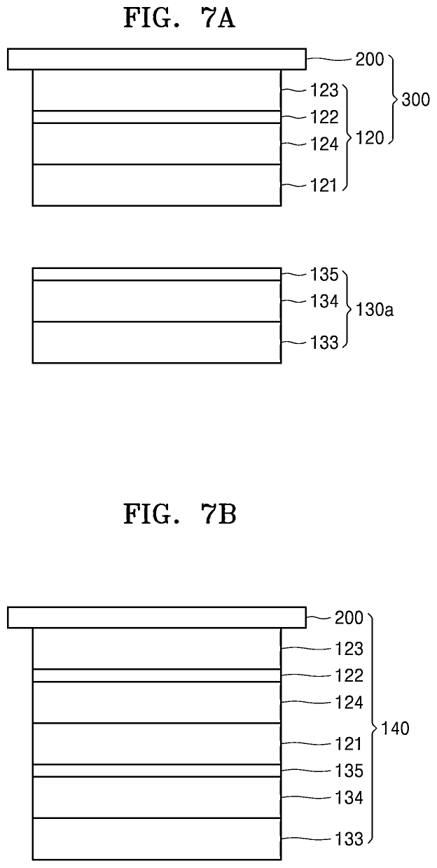

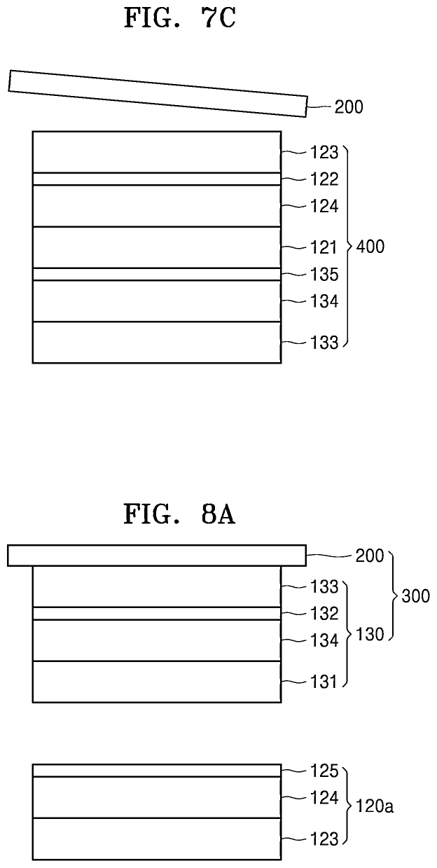

FIGS. 7A to 7C are schematic diagrams of a method of preparing an electrochemical battery according to an embodiment.

An electrode-solid electrolyte layer assembly is provided according to the disclosed method.

The electrode-solid electrolyte layer assembly may be, for example, a cathode-solid electrolyte layer assembly 120. For example, referring to FIG. 7A, the cathode-solid electrolyte layer assembly 120 may have the structure of solid electrolyte layer 121/electrode active material layer 124/interlayer 122/conductive substrate 123.

In this case, referring to FIG. 7A, an anode 130a is separately provided. The anode 130a may be prepared by positioning an anode active material layer 134 on an anode current collector 133. The method by which the anode active material layer 134 is disposed may be a described method by which the stacked structure thin film 300 is disposed. A thickness of the anode active material layer 133 prepared by a dry method may be, for example, about 0.5 μm to about 10 μm, about 0.5 μm to about 5 μm, about 0.5 μm to about 4 μm, about 0.5 μm to about 3 μm, about 0.5 μm to about 2 μm, or about 0.5 μm to about 1 μm, but is not limited to the disclosed ranges and may be appropriately adjusted within a range that allows for the preparation of a stacked structure thin film. The anode active material layer 134 may be positioned by a wet method. A thickness of the anode active material layer 134 may be, for example, about 0.5 μm to about 50 μm, about 0.5 μm to about 20 μm, about 0.5 μm to about 10 μm, about 0.5 μm to about 5 μm, about 0.5 μm to about 4 μm, about 0.5 μm to about 3 μm, about 0.5 μm to about 2 μm, or about 0.5 μm to about 1 μm, but is not limited to the disclosed ranges and may be appropriately adjusted in accordance with a desired battery shape.

The anode 130a may be prepared by the following wet method as an example, but is not necessarily limited to this method and may be modified in accordance with desired conditions.

First, an anode active material composition is prepared by mixing the disclosed anode active material, a conductive material, a binder, and a solvent. The prepared anode active material composition is directly coated and dried on a copper current collector, to produce an anode plate having an anode active material layer formed thereon. The anode active material composition may be cast on a separate support, and a film exfoliated therefrom may be laminated on a copper current collector, to produce an anode plate having an anode active material layer formed thereon.

Examples of the conductive material may include: carbon black, graphite powder, natural graphite, artificial graphite, acetylene black, Ketjenblack, and carbon fibers; carbon nanotubes; metal powder, metal fibers, or metal tubes, such as copper, nickel, aluminum, silver, etc.; and conductive polymers such as polyphenylene derivatives, and the like. The conductive material is not limited to the disclosed components and may be any suitable material that is used as a conductive material in the relevant technical field.

Examples of the binder may include a vinylidene fluoride/hexafluoropropylene copolymer, polyvinylidene fluoride, polyacrylonitrile, polymethylmethacrylate, polytetrafluoroethylene (“PTFE”), a combination thereof, a styrene butadiene rubber-based polymer, polyacrylic acid, lithium-substituted polyacrylic acid, polyamideimide, polyimide, etc. The binder is not limited thereto and may be any suitable material that is used in the relevant technical field.

Examples of the solvent may include N-methylpyrrolidone (“NMP”), acetone, water, etc. The solvent is not limited thereto and may be any suitable material that is used in the relevant technical field.

It is also possible to create pores inside the electrode plate by further adding a plasticizer and a pore forming agent to the anode active material composition.

The amounts of the anode active material, the conductive material, the binder, and the solvent used in the anode are at a level commonly used in lithium batteries. Depending on the intended use and composition of a lithium battery, one or more of the conductive material, the binder, and the solvent can be left out.

The amount of a binder included in the anode may be about 0.1 weight percent (wt %) to about 10 wt %, or about 0.1 wt % to about 5 wt %, with respect to the total weight of the anode active material layer. The amount of a conductive material included in the anode may be about 0.1 wt % to about 10 wt %, or about 0.1 wt % to about 5 wt %, with respect to the total weight of the anode active material layer. The amount of an anode active material included in the anode may be about 0.1 wt % to about 99 wt %, about 0.1 wt % to about 90 wt %, about 0.1 wt % to about 50 wt %, about 0.1 wt % to about 30 wt %, about 0.1 wt % to about 20 wt %, or about 0.1 wt % to about 10 wt %, with respect to the total weight of the anode active material layer.

Subsequently, a conductive adhesive layer 135 may be positioned on the anode active material layer 134.

The conductive adhesive layer 135 may include a conductive material and a binder. The conductive adhesive layer 135 may serve to bind the anode 130a and a cathode-solid electrolyte layer assembly together.

The conductive material included in the conductive adhesive layer 135 may be a conductive material used in the preparation of the anode active material layer composition. The conductive material may be, for example, a carbon-based conductive material. The binder may be a binder that is used in the preparation of the anode active material layer composition.

The conductive adhesive layer 135 may be positioned on the anode active material layer 134 by coating and drying a composition containing a carbon-based conductive material, a binder, and a solvent, on the anode active material layer 134.

Subsequently, referring to FIG. 7B, the anode-solid electrolyte layer assembly is positioned on the anode 130a so as to bring the conductive adhesive layer 135 and the solid electrolyte layer 121 in contact with each other, to produce a third structure 140.

Referring to FIG. 7C, a secondary battery 400 is formed by separating the release layer 200 from the third structure 140. The secondary battery 400 is, for example, an all-solid secondary battery.

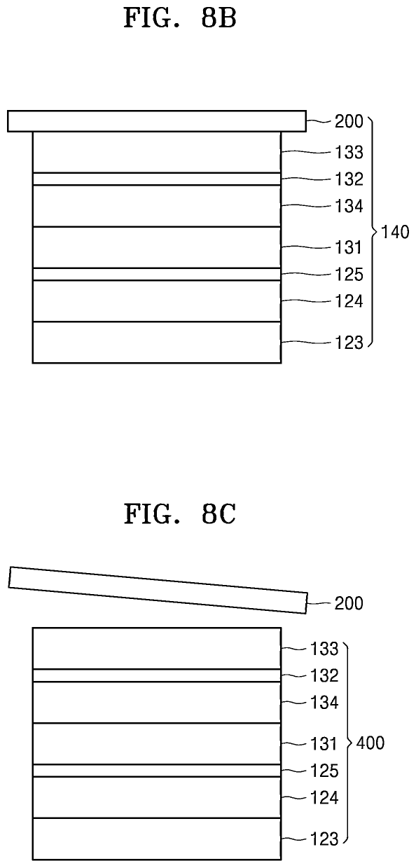

FIGS. 8A to 8C are schematic diagrams of a method of preparing an electrochemical battery according to an embodiment.

The electrode-solid electrolyte layer assembly may be, for example, an anode-solid electrolyte layer assembly 130. For example, referring to FIG. 8A, the anode-solid electrolyte layer assembly 130 may have the structure of the solid electrolyte layer 131/the electrode active material layer 134/the interlayer 132/the conductive substrate 133.

In this case, a cathode 120a is separately provided. Referring to FIG. 8A, the cathode 120a may be prepared by positioning a cathode active material layer 124 on a cathode current collector 124. The method by which the cathode active material layer 124 is positioned may be a described method by which an interlayer of the stacked structure thin film is positioned. A thickness of the cathode active material layer 124 prepared by a dry method may be, for example, about 0.5 μm to about 10 μm, about 0.5 μm to about 5 μm, about 0.5 μm to about 4 μm, about 0.5 μm to about 3 μm, about 0.5 μm to about 2 μm, or about 0.5 μm to about 1 μm, but is not necessarily limited to the disclosed ranges and may be appropriately adjusted within a range that allows for the preparation of a stacked structure thin film. The cathode active material layer 124 may be positioned by a wet method. A thickness of the cathode active material layer may be, for example, about 0.5 μm to about 50 μm, about 0.5 μm to about 20 μm, about 0.5 μm to about 10 μm, about 0.5 μm to about 5 μm, about 0.5 μm to about 4 μm, about 0.5 μm to about 3 μm, about 0.5 μm to about 2 μm, or about 0.5 μm to about 1 μm, but is not necessarily limited to the disclosed ranges and may be appropriately adjusted in accordance with a desired battery shape.

The cathode 120a may be prepared by the following wet method as an example, but is not limited to this method and may be modified according to desired conditions.

First, a cathode active material composition is prepared by mixing a cathode active material, a conductive material, a binder, and a solvent, described herein. The prepared cathode active material composition is directly coated and dried on an aluminum current collector, to produce a cathode plate having a cathode active material layer formed thereon. The cathode active material composition may be cast on a separate support, and a film exfoliated therefrom may be laminated on an aluminum current collector, to produce a cathode plate having a cathode active material layer formed thereon.

The conductive material, the binder, and the solvent may be a component used in the preparation of the anode active material composition.

It is also possible to create pores inside the electrode plate by further adding a plasticizer and a pore forming agent to the cathode active material composition.

The amounts of the cathode active material, the conductive material, the binder, and the solvent used in the cathode are at a level commonly used in lithium batteries. Depending on the intended use and composition of a lithium battery, one or more of the conductive material, the binder, and the solvent can be left out.

The amount of a binder included in the cathode may be about 0.1 wt % to about 10 wt %, or about 0.1 wt % to about 5 wt % with respect to the total weight of the cathode active material layer. The amount of a conductive material included in the cathode may be about 0.1 wt % to about 10 wt %, or about 0.1 wt % to about 5 wt %, with respect to the total weight of the cathode active material layer. The amount of a cathode active material included in the cathode may be about 0.1 wt % to about 99 wt %, about 0.1 wt % to about 90 wt %, about 0.1 wt % to about 50 wt %, about 0.1 wt % to about 30 wt %, about 0.1 wt % to about 20 wt %, or about 0.1 wt % to about 10 wt %, of the total weight of the cathode active material layer.

Subsequently, a conductive adhesive layer 125 may be positioned on the cathode active material layer 124.

The conductive adhesive layer 125 may include a conductive material and a binder. The conductive adhesive layer 125 may serve to bind the cathode 120a and an anode-solid electrolyte layer assembly together.

The conductive material included in the conductive adhesive layer 125 may be a conductive material used in the preparation of the cathode active material layer composition. The conductive material may be, for example, a carbon-based conductive material. The binder may be a binder that is used in the preparation of the cathode active material layer composition.

The conductive adhesive layer 125 may be positioned on the cathode active material layer 124 by coating and drying a composition containing a carbon-based conductive material, a binder, and a solvent, on the cathode active material layer 124.

Subsequently, referring to FIG. 8B, the anode-solid electrolyte layer assembly is positioned on the cathode 120a so as to bring the conductive adhesive layer 125 and the solid electrolyte layer 131 in contact with each other, to produce a secondary battery 400. The secondary battery 400 is, for example, an all-solid secondary battery.

Hereinbelow, the present inventive concept will be described in greater details with the embodiments and comparative examples. However, the following embodiments are for illustrative purpose only and shall not be construed as limiting the scope of the present inventive concept.

### Preparation of Stacked Structure Thin Film

### Example 1: Substrate/Ti (10 nm)/Cu (1 μm)/LiPON (500 nm)/Ti (10 nm)/Ni (2 μm)

A titanium (Ti) layer having a thickness of 10 nanometers (nm) was deposited by sputtering as a first interlayer on a glass substrate. Subsequently, a copper (Cu) layer having a thickness of 1 micrometer (μm) was deposited by sputtering as a base layer 103 on the first interlayer, to form a first structure.

A lithium phosphorus oxynitride (“LiPON”) solid electrolyte layer having a thickness of 500 nm was deposited on the Cu layer by sputtering. A titanium (Ti) layer having a thickness of 10 nm to 20 nm was deposited by sputtering as a second interlayer on the solid electrolyte layer. A nickel (Ni) conductive substrate having a thickness of 2 μm was deposited by sputtering on the second interlayer to form a second structure. The conductive substrate acts as a stress source that provides a stress for separating an electrolyte layer from a base layer. The residual stress of the conductive substrate was measured using a stress measurement system (FSM 900 TC, FSM). The residual stress of the Ni conductive substrate was 500 megaPascals (MPa). A thermal release tape was attached onto the conductive substrate.

By pulling the thermal release tape, the second structure was exfoliated from the first structure. As the conductive substrate provided a stress that is sufficient for exfoliating the solid electrolyte layer, 100% of the surface area of the deposited solid electrolyte layer was exfoliated from the base layer.

The thermal release tape was separated by heating the exfoliated stacked structure thin film having the thermal release layer at 100° C. for 1 minute, to produce a stacked structure thin film. The surface area of the stacked structure thin film was 1 square centimeters (cm²).

### Example 2: Substrate/Ti (10 nm)/Cu (1 μm)/LiPON (500 nm)/Ti (10 nm)/Ni (1 μm)

A stacked structure thin film was prepared in the same process as described in Example 1, except that the thickness of the Ni conductive substrate was changed to 1 μm.

The residual stress of the Ni conductive substrate was 300 MPa. As the conductive substrate provided a stress that is sufficient for exfoliating the solid electrolyte layer, 100% of the surface area of the deposited solid electrolyte layer was exfoliated from the base layer.

### Example 3: Substrate/Ti (10 nm)/Au (1 μm)/LiPON (500 nm)/Ti (10 nm)/Ni (2 μm)

A stacked structure thin film was prepared in the same process as described in Example 1, except that the base layer was changed from the Cu layer to a gold (Au) layer.

The residual stress of the Ni conductive substrate was 500 MPa. As the conductive substrate provided a sufficient stress to exfoliate the solid electrolyte layer, 100% of the area of the solid electrolyte layer deposited was exfoliated from the base layer.

### Example 4: STO (500 nm)/SAO (20 nm)/STO (5 nm)/LLTO (200 nm)/Ti (10 nm)/Ni (1 μm)

On a SrTiO₃ (“STO”) substrate, a Sr₃Al₂O₆ (“SAO”) layer having a thickness of 20 nm was deposited as a first interlayer by pulsed laser deposition (“PLD”). Subsequently, a SrTiO₃ (“STO”) layer having a thickness of 5 nm, was deposited on the first interlayer as a base layer 103 by PLD, to form a first structure.

On a SrTiO₃ (“STO”) layer, a Li_{0.33}La_{0.55}TiO₃(“LLTO”) solid electrolyte layer having a thickness of 250 nm was deposited by pulsed laser deposition. On the solid electrolyte layer, a titanium (Ti) layer having a thickness of 10 nm was deposited as a second interlayer by PLD. On the second interlayer, a nickel (Ni) conductive substrate having a thickness of 1 μm was deposited by PLD, to form a second structure. The conductive substrate acts as a stress source providing a stress for separating the electrolyte layer from the base layer. The stress of the conductive substrate was measured for residual stress by using a stress measurement device (FSM 900 TC, FSM). The residual stress of the nickel (Ni) conductive substrate was 45 MPa. A thermal release tape was attached onto the conductive substrate.

The second structure was exfoliated from the first structure by pulling the thermal release tape. As the conductive substrate provided a sufficient stress for exfoliating the solid electrolyte layer, 100% of the surface area of the deposited solid electrolyte layer was exfoliated from the base layer.

The exfoliated stacked structure thin film was heated at 100° C. for 1 minute to remove the thermal release tape therefrom to prepare the stacked structure thin film. An area of the stacked structure thin film was 0.25 cm².

### Comparative Example 1: Substrate/Ti (10 nm)/Cu/LiPON (500 nm)/Ti (10 nm)/Ni (0.5 μm)

A stacked structure thin film was prepared in the same process as described in Example 1, except that the thickness of the Ni conductive substrate was changed to 0.5 μm.

The residual stress of the Ni conductive substrate was 125 MPa. As the thickness of the Ni conductive substrate decreased, the Ni conductive substrate was unable to provide a stress that is sufficient for exfoliating the solid electrolyte layer.

Even upon pulling the thermal release tape, only 20% of the surface area of the deposited solid electrolyte layer was exfoliated, and 80% of the surface area of the solid electrolyte layer remained on the base layer.

The stacked structure thin film was not obtained.

### Comparative Example 2: Substrate/Ti (10 nm)/SiO₂/LiPON (500 nm)/Ti (10 nm)/Ni (2 μm)

A stacked structure thin film was prepared in the same process as described in Example 1, except that the base layer was changed from the Cu layer to a silica (SiO₂) layer.

The residual stress of the Ni conductive substrate was 500 MPa, but the base layer and the solid electrolyte layer were adhered more strongly than the residual stress.

Even upon pulling the thermal release tape, the solid electrolyte layer failed to be separated from the base layer, and only the interlayer/conductive substrate laminate was separated.

The stacked structure thin film was not obtained.

### Comparative Example 3: Substrate/Ti (10 nm)/Pt/LiPON (500 nm)/Ti (10 nm)/Ni (1 μm)

A stacked structure thin film was prepared in the same process as described in Example 1, except that the base layer was changed from the Cu layer to a platinum (Pt) layer.

The residual stress of the Ni conductive substrate was 300 MPa, but the base layer and the solid electrolyte layer were adhered more strongly than the residual stress.

Even upon pulling the thermal release tape, the solid electrolyte layer failed to be separated from the base layer, and only the interlayer/conductive substrate laminate was separated.

The stacked structure thin film was not obtained.

### Preparation of Solid Electrolyte Free-Standing Film

### Example 5: LiPON (500 nm)

The stacked structure thin film prepared in Example 1 was immersed in a nitric acid solution, selectively etching and removing the conductive substrate positioned on the solid electrolyte layer.

The solid electrolyte layer was taken out of the nitric acid solution, washed with distilled water, and then dried, to produce a LiPON solid electrolyte layer free-standing film.

### Example 6: LLTO (200 nm)

The stacked structure thin film prepared in Example 4 was immersed in a nitric acid solution to selectively etch and remove the conductive substrate disposed on the solid electrolyte layer.

The solid electrolyte layer was taken out of the nitric acid solution, washed with distilled water, and then dried to obtain a LLTO solid electrolyte layer free-standing film.

### Preparation of Secondary Battery

### Example 7: Cu/Si—Li alloy/LiPON (500 nm)/LCO (2 μm)/Ti (10 nm)/Ni (2 μm)

### Cathode-Electrolyte Layer Assembly

A titanium (Ti) layer having a thickness of 10 nm was deposited by sputtering as a first interlayer on a glass substrate. Subsequently, a copper (Cu) layer having a thickness of 1 μm was deposited by sputtering as a base layer on the first interlayer, to form a first structure.

A LiPON solid electrolyte layer having a thickness of 500 nm was deposited on the Cu layer by sputtering. On the solid electrolyte layer, a LiCoO₂ layer having a thickness of 2 μm was deposited as a cathode active material by ALD.

On the cathode active material layer, a titanium (Ti) layer having a thickness of 10 nm to 20 nm was deposited by sputtering as a second interlayer. On the second interlayer, a nickel (Ni) conductive substrate having a thickness of 2 μm was deposited by sputtering, to form a second structure. The conductive substrate acts as a stress source that provides a stress for separating an electrolyte layer from a base layer. The residual stress of the conductive substrate was measured using a stress measurement system (FSM 900 TC, FSM). The residual stress of the Ni conductive substrate was 500 MPa. A thermal release tape was attached onto the conductive substrate.

By exfoliating the second structure from the first structure by pulling the thermal release tape, a cathode-solid electrolyte layer assembly was prepared.

As the conductive substrate provided a sufficient stress to exfoliate the solid electrolyte layer, 100% of the surface area of the deposited solid electrolyte layer was exfoliated from the base layer.

### Anode

On the Cu substrate, a Si—Li alloy layer having a thickness of 2 μm was deposited by sputtering as an anode active material, to form an anode. A conductive adhesive layer was positioned on the Si—Li alloy layer.

### Secondary Battery

A cathode-solid electrolyte layer assembly was positioned on an anode such that a conductive adhesive layer of the anode and a solid electrolyte layer were in contact with each other, to produce a cathode/solid electrolyte layer/anode assembly. The surface area of the assembly was 1 cm².

A secondary battery was prepared by heating the cathode/solid electrolyte layer/anode assembly for 1 minute at 100° C. and removing the thermal release tape therefrom.

### Example 8: Cu/LCO (2 μm)/LiPON (500 nm)/Si—Li alloy (2 μm)/Ti (10 nm)/Ni (2 μm)

### Anode-Electrolyte Layer Assembly

On a glass substrate, a titanium (Ti) layer having a thickness of 10 nm was deposited as a first interlayer by sputtering. Subsequently, on the first interlayer, a copper (Cu) layer having a thickness of 1 μm was deposited by sputtering as a base layer, to form a first structure.

A LiPON solid electrolyte layer having a thickness of 500 nm was deposited on the Cu layer by sputtering. On the solid electrolyte layer, a Si—Li alloy layer having a thickness of 2 μm was deposited by ALD as an anode active material.

On the anode active material layer, a titanium (Ti) layer having a thickness of 10 nm to 20 nm was deposited by sputtering as an interlayer. On the interlayer, a nickel (Ni) conductive substrate having a thickness of 2 μm was deposited by sputtering, to form a second structure. The conductive substrate acts as a stress source that provides a stress for separating an electrolyte layer from a base layer. The residual stress of the conductive substrate was measured using a stress measurement system (FSM 900 TC, FSM). The residual stress of the Ni conductive substrate was 500 MPa. A thermal release tape was attached onto the conductive substrate.

By exfoliating the second structure from the first structure by pulling the thermal release tape, an anode-solid electrolyte layer assembly was prepared.

As the conductive substrate provided a sufficient stress to exfoliate the solid electrolyte layer, 100% of the area of the solid electrolyte layer deposited was exfoliated from the base layer.

### Cathode

On an aluminum (Al) substrate, a LiCoO₂ layer having a thickness of 2 μm was deposited by sputtering as a cathode active material, to form a cathode. A conductive adhesive layer was positioned on the LiCoO₂ layer.

### Secondary Battery

An anode-solid electrolyte layer assembly was positioned on a cathode such that a conductive adhesive layer of the cathode and a solid electrolyte layer were in contact with each other, to produce an anode/solid electrolyte layer/anode assembly. The surface area of the assembly was 1 cm².

A secondary battery was prepared by heating the cathode/solid electrolyte layer/anode assembly for 1 minute at 100° C. and removing the thermal release tape therefrom.

### Evaluation Example 1: Flexibility Evaluation

A bending test was conducted on the stacked structure thin films prepared in Examples 1 to 3, to evaluate flexibility.

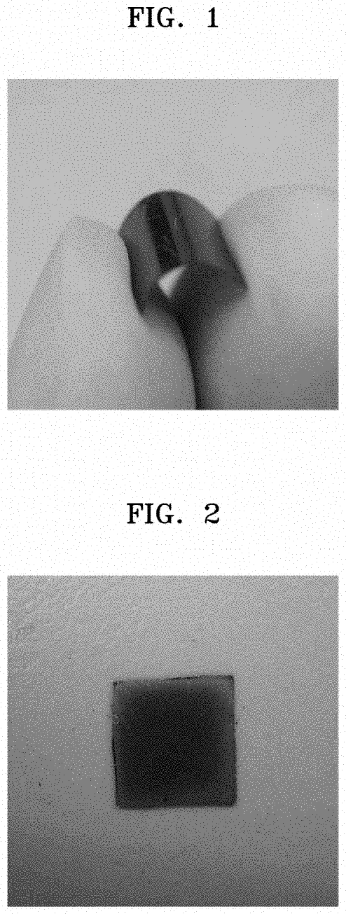

As shown in FIG. 1, the stacked structure thin film prepared in Example 1 was able to bend smoothly. The curvature of radius of the bent stacked structure thin film was 0.17 mm.

As shown in FIG. 2, it was confirmed that the stacked structure thin film prepared in Example 1 was a free-standing film that, even after the bending test, retains the same unbent shape as before without suffering a defect on the surface of the solid electrolyte layer.

Tt was confirmed that the stacked structure thin film was a flexible free-standing film.

### Evaluation Example 2: Measurement of Surface Roughness

For the stacked structure thin films prepared in Examples 1 to 3, a surface roughness of the exfoliated solid electrolyte layer was measured using an atomic force microscope (“AFM”).

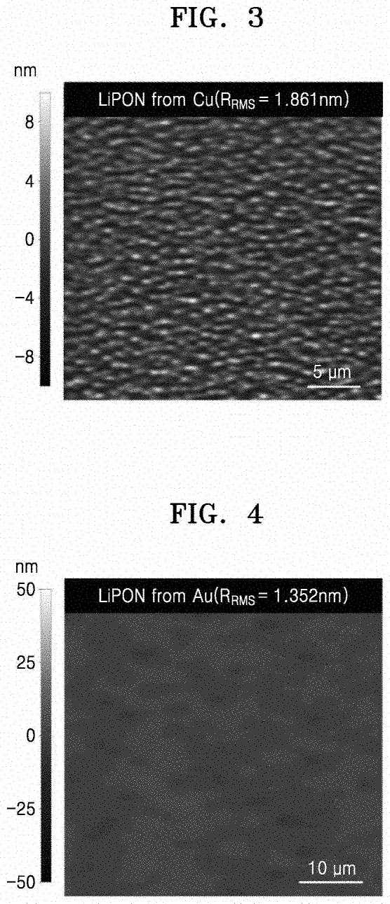

The surface roughness was root mean square (RMS) roughness (R_{RMS}). A part of the measurement results is shown in Table 1 and FIGS. 3 and 4.

TABLE 1

| | Surface roughness |
|---|---|
| | (R_{RMS}) (nm) |
| Example 1 | 1.352 |
| Example 3 | 1.861 |

As shown in Table 1, the surface roughness of the stacked structure thin films prepared in Example 1 and Example 3 was less than 2 nm.

### Evaluation Example 3: Measurement of Ion Conductivity (“LiPON”)

A stack having a LiPON solid electrolyte layer disposed on the first structure prepared in Example 1 was prepared. On the solid electrolyte layer of the prepared stack, two titanium (Ti) layers (thickness 3 nm) spaced apart from each other were deposited, respectively, and on each of the titanium (Ti) layers, a gold (Au) electrode (thickness 100 nm) was deposited to prepare a solid electrolyte sample. The prepared solid electrolyte sample was measured for impedance by the 2-probe method using an impedance analyzer (Solartron 1400A/1455A impedance analyzer). The frequency range was 0.1 hertz (Hz) to 1 megahertz (MHz), and the amplitude voltage was 10 millivolts (mV).

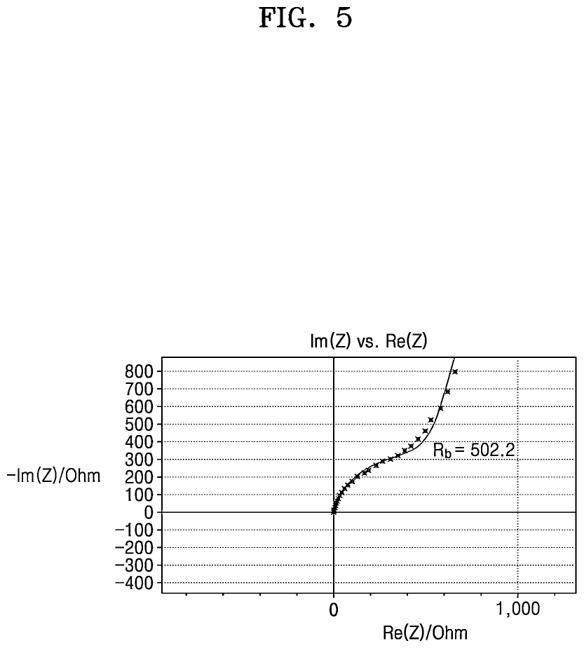

The measurement was made at 25° C. under an ambient atmosphere. A Nyquist plot for the impedance measurement result is shown in FIG. 5. FIG. 5 and ion conductivity obtained from the thickness of the solid electrolyte layer was measured, and the result thereof is shown in Table 2.

TABLE 2

| | Ion conductivity |
|---|---|
| | (siemens per centimeter |
| | (S/cm)) |
| Example 1 | 1.2 × 10⁻⁶ |

As shown in Table 2, the ion conductivity of the solid electrolyte layer prepared in Example 1 was 1×10⁻⁶ S/cm or greater.

### Evaluation Example 4: Measurement of Ion Conductivity (“LLTO”)

The solid electrolyte layer was measured for ion conductivity, following the same process as described in Evaluation Example 3, except that a stack with an LLTO solid electrolyte layer disposed on the first structure prepared in Example 4 was used and the measurement temperature was changed to 100° C.

The results of measurement are shown in Table 3.

TABLE 3

| | Ion Conductivity |
|---|---|
| | (S/cm) |
| Example 1 | 2.98 × 10⁻⁵ |

As shown in Table 2, the ion conductivity of the solid electrolyte layer prepared in Example 4 was 10⁻⁶ S/cm or greater.

The ion conductivity at 25° C. of the solid electrolyte layer, extrapolated from ion conductivity values of the solid electrolyte layer according to temperature was 2.6×10⁻⁶ S/cm, which was equal to or greater than 10⁻⁶ S/cm.

### Evaluation Example 5: Evaluation of Charge-Discharge Characteristics

The secondary batteries prepared in Example 7 and Example 8 were charged at a constant current rate of 0.1 C at 25° C. until a voltage of 4.2 volts (V) (vs. Li) was reached, and were discharged at a constant current rate of 0.1 C until a voltage of 3.0 V (vs. Li) was reached. As a result of this charge-discharge test, it was confirmed that charging and discharging were possible without short-circuits.

As described herein, an all-solid secondary battery associated with the present example was applicable to various portable devices, vehicles, and the like.

According to an aspect, when the stacked structure thin film has a thickness of about 5 μm or less and is a flexible free-standing film, electrodes, electrode-electrolyte assemblies, batteries, or a combination thereof of various structures can be realized.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A stacked structure comprising:
a conductive substrate; and
a solid electrolyte layer disposed on one surface of the conductive substrate,
wherein the solid electrolyte layer comprises an inorganic solid electrolyte, and
wherein the stacked structure is a flexible free-standing film having a thickness of about 5 micrometers or less.

2. The stacked structure of claim 1, wherein the stacked structure has a radius of curvature of about 10 millimeters or less.

3. The stacked structure of claim 1, wherein the solid electrolyte layer has a thickness of about 70% or less of a thickness of the conductive substrate, and the solid electrolyte layer has a thickness of about 1 micrometers or less.

4. The stacked structure of claim 1, wherein a root mean square roughness of a surface of the solid electrolyte layer is about 5 nanometers or less.

5. The stacked structure of claim 1, wherein the solid electrolyte layer has a surface area of about 50% or less of a surface area of the conductive substrate, and the solid electrolyte layer is an exfoliated layer.

6. The stacked structure of claim 1, wherein the solid electrolyte has an ion conductivity of about 1×10⁻⁸ siemens per centimeter or greater.

7. The stacked structure of claim 1, wherein the inorganic solid electrolyte is an oxide solid electrolyte.

8. The stacked structure of claim 1, wherein the oxide solid electrolyte comprises lithium phosphorus oxynitride, Li₃ₓLa_{(2/3-x)(1/3-2x)}TiO₃, wherein 0.04<x<0.16, Li₁₊ₓAlₓTi₂₋ₓ(PO₄)₃, wherein 0<x<2, Li₁₊ₓAlₓGe₂₋ₓ(PO₄)₃, wherein 0<x<2, Li_{1+x+y}AlₓTi₂₋ₓSi_{y}P_{3-y}O₁₂, wherein 0<x<2, 0≤y<3, BaTiO₃, Pb(Zr, Ti)O₃, Pb₁₋ₓLaₓZr_{1-y}Ti_{y}O₃, wherein 0≤x<1, 0≤y<1, Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃, wherein 0<x<2, 0<y<3, LiₓAl_{y}Ti_{z}(PO₄)₃, wherein 0<x<2, 0<y<1, 0<z<3, Li_{1+x+y}(Al, Ga)ₓ(Ti, Ge)₂₋ₓSi_{y}P_{3-y}O₁₂, wherein 0≤x≤1 0≤y≤1, LiₓLa_{y}TiO₃, wherein 0<x<2, 0<y<3, Li₂O, LiOH, Li₂CO₃, LiAlO₂, Li₂O—Al₂O₃—SiO₂—P₂O₅—TiO₂—GeO₂, Li₃₊ₓLa₃M₂O₁₂, wherein M is Te, Nb, or Zr, and 1≤x≤10, Li₇La₃Zr₂O₁₂, or Li₃₊ₓLa₃Zr₂₋ₐMₐO₁₂, wherein M is Ga, W, Nb, Ta, or Al, 0<a<2, and 1≤x≤10, or a combination thereof.

9. The stacked structure of claim 1, wherein the conductive substrate has a thickness of about 4 micrometers or less.

10. The stacked structure of claim 1, wherein the inorganic solid electrolyte comprises lithium phosphorus oxynitride and the conductive substrate has a residual stress of about 200 megaPascals or greater, or
the inorganic solid electrolyte comprises Li₃ₓLa_{(2/3-x)(1/3-2x)}TiO₃, wherein 0.04<x<0.16, and the conductive substrate has a residual stress of about 50 megaPascals or less.

11. The stacked structure of claim 1, wherein the conductive substrate comprises nickel, aluminum, copper, an alloy thereof, or a combination thereof.

12. The stacked structure of claim 1, further comprising an interlayer disposed between the conductive substrate and the solid electrolyte layer, wherein the interlayer has a thickness of about 100 nanometers or less, and the interlayer comprises titanium, chromium, tungsten, niobium, an alloy thereof, or a combination thereof.

13. The stacked structure of claim 1, further comprising a release layer disposed on an other surface of the conductive substrate.

14. The stacked structure of claim 1, further comprising an electrode active material layer disposed between the conductive substrate and the solid electrolyte layer, wherein the electrode active material layer comprises a cathode active material or an anode active material.

15. An electrochemical battery comprising:
a first electrode-electrolyte assembly comprising
a first electrode comprising a first electrode active material layer, and
a flexible free-standing film comprising
a conductive substrate, and
a solid electrolyte layer disposed on one surface of the conductive substrate,
wherein the solid electrolyte layer comprises an inorganic solid electrolyte, and
wherein the flexible free-standing film has a thickness of about 5 micrometers or less; and
a second electrode comprising a second electrode active material layer.

16. A method of preparing a stacked structure, the method comprising:
providing a first structure comprising a base layer;
forming a second structure by sequentially disposing a solid electrolyte layer and a conductive substrate on one surface of the base layer; and
exfoliating the solid electrolyte layer from the base layer to prepare the stacked structure,
wherein
the solid electrolyte layer comprises an inorganic solid electrolyte, and
the stacked structure is a flexible free-standing film having a thickness of about 5 micrometers or less.

17. The method of claim 16, wherein the providing of a first structure comprising a base layer comprises providing a substrate, disposing a first interlayer on the substrate, and disposing the base layer on the first interlayer,
wherein the substrate comprises a metal, a metal oxide, or glass, and the base layer comprises a metal or a metal oxide,
wherein the substrate, the base layer, or a combination thereof comprises a metal, the metal comprising Sc, V, Cr, Mn, Fe, Co, Ni, Cu, Zn, Y, Zr, Nb, Mo, Ru, Rh, Pd, Ag, Cd, Hf, Ta, W, Re, Os, Ir, Pt, Au, or an alloy thereof, and
wherein the substrate, the base layer, or a combination thereof comprises a metal oxide, the metal oxide comprising SrTiO₃, Sr₃Al₂O₆, or a combination thereof.

18. The method of claim 16, wherein in the forming of a second structure, the solid electrolyte layer comprises lithium phosphorus oxynitride and the conductive substrate has a residual stress of about 200 megaPascals or greater, or
the solid electrolyte layer comprises Li₃ₓLa_{(2/3-x)(1/3-2x)}TiO₃, wherein 0.04<x<0.16, and the conductive substrate has a residual stress of about megaPascals or less.

19. The method of claim 16, wherein the forming of a second structure further comprises disposing a release layer on the conductive substrate, and
a surface area of the solid electrolyte layer in the stacked structure is about 50% or greater of a surface area of the solid electrolyte layer positioned on the base layer.

20. The method of claim 16, wherein the forming of a second structure further comprises disposing an electrode active material layer on the solid electrolyte layer prior to disposing the conductive substrate on the solid electrolyte layer.
